(19) United States
(12) Patent Application Publication
(10) Pub. No.: US 2024/0194976 A1
(43) Pub. Date: Jun. 13, 2024

(54) HIGH VOLTAGE BATTERY MODULE

(71) Applicants: Hyundai Motor Company, Seoul (KR); Kia Corporation, Seoul (KR)

(72) Inventors: Kyung Sang YU, Uijeongbu-Si (KR); Jun Young Lim, Seoul (KR)

(73) Assignees: Hyundai Motor Company, Seoul (KR); Kia Corporation, Seoul (KR)

(21) Appl. No.: 18/201,447

(22) Filed: May 24, 2023

(30) Foreign Application Priority Data
Dec. 9, 2022 (KR) 10-2022-0171436

(51) Int. Cl. H01M 10/6566; H01M 10/613; H01M 10/6556; H01M 50/204

(52) U.S. Cl. CPC H01M 10/6566; H01M 10/613; H01M 10/6556; H01M 50/204

(57) ABSTRACT

A high voltage battery module includes a battery cell laminate formed by arranging a plurality of high voltage battery cells, an upper housing including an opening at a position corresponding to an inlet of a battery module case on an upper surface of the battery cell laminate and including a cooling flow path of outside air introduced through the inlet formed thereon, and a baffle configured to guide the outside air passing through the opening to flow to the outside of the battery cell laminate along the cooling flow path and formed in a curved surface including an inflection point.

### CROSS-REFERENCE TO RELATED APPLICATION

The present application claims priority to Korean Patent Application No. 10-2022-0171436 filed on Dec. 9, 2022, the entire contents of which is incorporated herein for all purposes by this reference.

### BACKGROUND OF THE PRESENT DISCLOSURE

### Field of the Present Disclosure

The present disclosure relates to a high voltage battery module, and more specifically, to a high voltage battery module configured for reducing a temperature deviation between a plurality of battery cells through the uniform distribution of an air volume of introduced outside air by improving differential pressure of a cooling flow path for an air-cooled high voltage battery cell.

### DESCRIPTION OF RELATED ART

In general, all of hybrid electric vehicles, fuel cell vehicles, and electric vehicles are driven by an electric motor and essentially provided with a high voltage battery for providing driving power to the electric motor.

Here, the high voltage battery is configured to supply necessary power while repeatedly charging and discharging while a vehicle travels, and the high voltage battery is usually composed of a plurality of battery modules.

Furthermore, each of the battery modules is composed of a plurality of battery sub-modules, and each of the sub-modules is composed of a plurality of high voltage battery cells.

As described above, the plurality of high voltage battery cells are coupled by an upper housing and a lower housing respectively supporting an upper portion and a lower portion, and in the instant case, the plurality of high voltage battery cells are inserted into the lower housing to be laminated face to face and assembled by fitting the upper housing into the upper portion of the high voltage battery cell to become the sub-module.

The high voltage battery cell may be manufactured in various types, and a pouched type high voltage battery cell widely used recently among various types of high voltage battery cells utilizes a flexible aluminum laminate sheet as an external member and thus has a shape which may be easily bent and also has recently attracted a lot of attention due to advantages such as low weight and low manufacturing cost.

Meanwhile, the high voltage batteries are largely classified into an air-cooled type or a water-cooled type according to a cooling medium, and in the air-cooled high voltage battery among them cool air, cool air passes between the plurality of high voltage battery cells to cool the battery cells through convective heat transfer.

Here, in the air-cooled high voltage battery, a space through which outside air can flow is configured on the upper portion and lower portion of the high voltage battery cell to secure a cooling flow path used for cooling, and the flow path is formed as a path of an inlet, the high voltage battery cell, a cooling fan, and an outlet duct, and in the instant case, it is important to distribute the outside air supplied through the inlet to the entire high voltage battery cell in a state in which pressure loss is minimized and minimize a temperature deviation between the plurality of high voltage battery cells.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery module, which may apply a three-dimensional baffle including a streamlined structure to an upper surface of a battery cell laminate at a position facing an inlet and allow the air volume of the outside air introduced through the inlet to be uniformly distributed to the battery cell laminate to improve differential pressure of a cooling flow path of an air-cooled battery cell, reducing a temperature deviation between a plurality of battery cells.

A battery module according to an exemplary embodiment of the present disclosure includes a battery cell laminate formed by arranging a plurality of battery cells, an upper housing including an opening at a position corresponding to an inlet of a battery module case on an upper surface of the battery cell laminate and including a cooling flow path of outside air introduced through the inlet formed thereon, and a baffle configured to guide the outside air passing through the opening to flow to the outside of the battery cell laminate along the cooling flow path and formed in a curved surface including an inflection point.

Here, the baffle may be coupled to the upper surface of the battery cell laminate and formed in a widthwise length relatively greater than a widthwise length of the opening.

The baffle may be formed to include the widthwise length relatively greater than the widthwise length of the opening downwardly from a boundary surface including the inflection point of an upper side having a length relatively shorter than the widthwise length of the opening.

The boundary surface may be formed to be shifted from a center portion of the opening to one side thereof.

Furthermore, the baffle may include a through hole passing through the inside and formed so that the outside air is introduced into the battery cell laminate.

Furthermore, a plurality of through holes are formed side by side along the cooling flow path.

Furthermore, the baffle may be positioned so that the inflection point is shifted from a center portion of the opening to one side to guide the flow of the outside air.

Furthermore, the upper housing may include a downward inclined portion formed to be inclined downwardly from a first end portion on which the opening is formed toward a second end portion facing the outside of the battery cell laminate.

The downward inclined portion may be positioned to overlap the baffle.

Meanwhile, a battery module according to another exemplary embodiment of the present disclosure includes a battery cell laminate formed by arranging a plurality of battery cells, an upper housing including an opening at a position corresponding to an inlet of a battery module case on an upper surface of the battery cell laminate and including a cooling flow path of outside air introduced through the inlet formed thereon, a baffle configured to guide the outside air passing through the opening to flow to the outside of the battery cell laminate along the cooling flow path and formed in a curved surface including an inflection point, and a through hole passing through the inside and formed so that the outside air is introduced into the battery cell laminate.

Here, a plurality of through holes may be formed side by side along the cooling flow path.

According to an exemplary embodiment of the present disclosure, it is possible to apply the three-dimensional baffle including the streamlined structure to the upper surface of the battery cell laminate at the position facing the inlet and allow the air volume of the outside air introduced through the inlet to be uniformly distributed to the battery cell laminate to improve the differential pressure of the cooling flow path of the air-cooled battery cell, reducing the temperature deviation between the plurality of battery cells.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a view showing a cooling flow path of a high voltage battery module according to an exemplary embodiment of the present disclosure:

FIG. 2 is a view showing a baffle of the high voltage battery module according to an exemplary embodiment of the present disclosure:

FIG. 3 is a view showing a coupled state of the baffle of the high voltage battery module according to an exemplary embodiment of the present disclosure:

FIG. 4 is a view showing an opening of an upper housing of the high voltage battery module according to an exemplary embodiment of the present disclosure:

FIG. 5 is a view showing a coupled state of a baffle of a high voltage battery module according to another exemplary embodiment of the present disclosure; and

FIG. 6 is a view showing a structure of the conventional high voltage battery module.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, exemplary embodiments of the present disclosure will be described in detail with reference to the accompanying drawings.

Advantages and features of the present disclosure, and methods for achieving them will become clear with reference to the exemplary embodiments described below in detail

However, the present disclosure is not limited by the exemplary embodiments included below but may be implemented in various different forms, and these embodiments are only provided to make the present disclosure of the present disclosure complete and completely inform those skilled in the art to which the present disclosure pertains of the scope of the present disclosure, and the present disclosure is defined by only the scope of the claims.

Furthermore, in the description of the present disclosure, when it is determined that related known technologies may obscure the gist of the present disclosure, a detailed description thereof will be omitted.

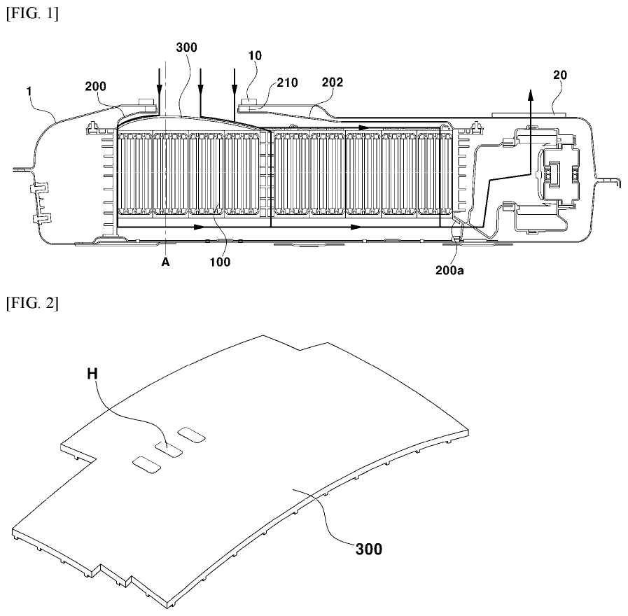

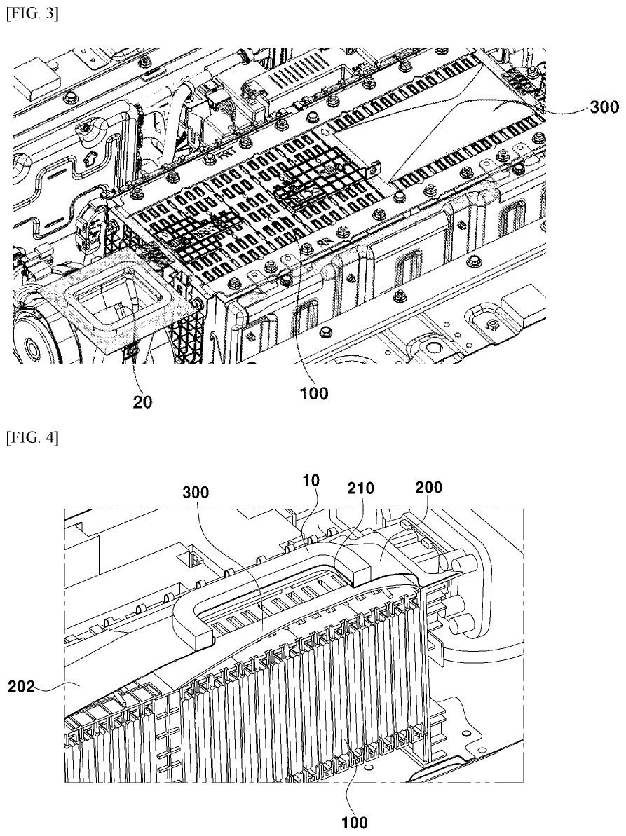

FIG. 1 is a view showing a cooling flow path of a high voltage battery module according to an exemplary embodiment of the present disclosure, FIG. 2 is a view showing a baffle of the high voltage battery module according to an exemplary embodiment of the present disclosure, and FIG. 3 is a view showing a coupled state of the baffle of the high voltage battery module according to an exemplary embodiment of the present disclosure.

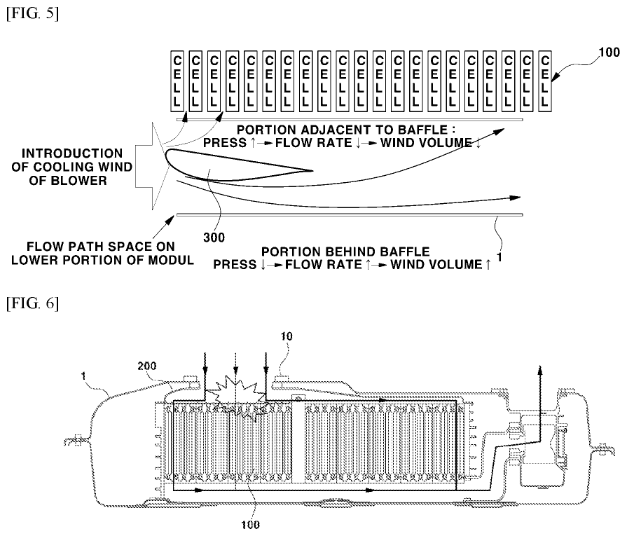

Furthermore, FIG. 4 is a view showing an opening of an upper housing of the high voltage battery module according to an exemplary embodiment of the present disclosure, and FIG. 5 is a view showing a coupled state of a baffle of a high voltage battery module according to another exemplary embodiment of the present disclosure.

In general, a plurality of battery laminates in a unit of cell laminated or provided use outside air as a means for cooling, which allows the outside air to pass between battery cells to implement cooling by convection.

To the present end, as shown in FIG. 6, a supply direction is conventionally perpendicular when outside air is supplied to a battery cell laminate 100 through an inlet 10, excessive pressure loss occurs, and the air volume of air distributed to the battery cells vertically positioned on the inlet 10 increases, and as a result, the air volume is reduced by the differential pressure generated on an outside of the battery cell laminate 100, and thus cooling performance is inevitably degraded.

In other words, in general, when a path of a fluid is abruptly changed, pressure loss is caused by a collision between particles in the fluid, and as in the related art shown in FIG. 6, when outside air is introduced and vertically collides with the battery cell laminate 100, collision pressure loss occurs, and cooling performance is degraded by a reduction in the air volume due to the generation of the differential pressure.

Furthermore, because excessive air volume is distributed to cells facing the inlet 10 when the outside air is vertically introduced as generally, the air volume distributed to battery cells disposed relatively far from the inlet 10 is insufficient, and thus a temperature deviation occurs between the plurality of battery cells, causing a problem of battery cell deterioration.

Therefore, it is important to uniformly distribute a flow rate of the outside air supplied through the inlet 10 between the plurality of battery cells, and to the present end, as shown in FIG. 1, a high voltage battery module according to an exemplary embodiment of the present disclosure may include a battery cell laminate 100, an upper housing 200, and a baffle 300.

In the battery cell laminate 100, each of high voltage battery cells is disposed side by side face to face and inserted into and supported by a lower housing 200a.

The upper housing 200 is coupled to the lower housing 200a so that a position of the battery cell laminate 100 is fixed.

Furthermore, the upper housing 200 includes an opening 210 at a position corresponding to an inlet 10 of a battery module case 1 on an upper surface of the battery cell laminate 100 and forms a cooling flow path through which the outside air introduced through the inlet 10 is discharged to an outlet 20 through the battery cell laminate 100.

Here, the upper housing 200 may include a downward inclined portion 202.

The downward inclined portion 202 is formed to be gradually inclined downwardly from one end portion on which the opening 210 is formed toward the other end portion facing an outside of the battery cell laminate 100 and positioned to overlap an inclined surface of the baffle 300 to guide the outside air introduced through the opening 210 to flow along a cooling flow path including a smaller cross-sectional area so that the outside air may be stably distributed to the outside of the battery cell laminate 100.

Meanwhile, the baffle 300 guides the outside air passing through the opening 210 to flow to the outside of the battery cell laminate 100 along the cooling flow path, and includes a curved surface including an inflection point, which is formed to be rounded, as shown in FIG. 2.

Conventionally, among the battery cells laminated or disposed so that the flow rate of the outside air supplied through the inlet 10 may be uniformly distributed to each of the battery cells, an upper portion of the battery cell to which air is excessively supplied is provided with the baffle 300 including a flat shape so that the flow rate of the outside air distributed may be adjusted.

However, due to the shape of the baffle 300, a collision pressure loss due to a vertical collision of the supplied outside air occurs on an upper surface of the baffle 300, which reduces the air volume outside the battery cell laminate 100 due to the generation of the differential pressure, and as a result, the cooling performance of the high voltage battery module is inevitably degraded.

On the other hand, because the baffle 300 according to the exemplary embodiment of the present disclosure may be formed in the curved surface including the inflection point to guide the flow of the outside air, it is possible to solve the conventional problem, that is, the problem that as the outside air is vertically supplied and collides with the baffle 300 and then the path is abruptly changed, the pressure loss is caused by the collision between the particles in the fluid included in the outside air.

As a result, the baffle 300 forms the cooling path of the outside air passing the opening 210 through the structure of the curved surface including the inflection point and the structure of the downward inclined portion 202 positioned to overlap the above structure and thus allows the outside air to flow to the outside of the battery cell laminate 100 disposed relatively far from the opening 210 along the cooling flow path so that the outside air may be distributed to the entire battery cell laminate 100.

Furthermore, because the baffle 300 can minimize the pressure loss due to the supplied outside air and prevent the generation of the differential pressure accordingly through the structure of the curved surface including the inflection point, the outside air including the increased air volume may be stably distributed to the outside of the battery cell laminate 100, and thus it is possible to prevent the occurrence of the temperature deviation between the battery cells, solving the problem of the battery cell deterioration due to the reduction in the cooling performance.

Furthermore, as shown in FIG. 3, the baffle 300 is coupled to the upper surface of the battery cell laminate 100 facing the inlet 10 and coupled in a widthwise length relatively greater than a widthwise length of the opening 210 as shown in FIG. 4.

As described above, because the baffle 300 includes the widthwise length relatively greater than the widthwise length of the opening 210, the baffle 300 is formed to include the cross-sectional area that becomes smaller toward the outside of the battery cell laminate 100 by the downward inclined portion 202, and thus, the outside air may flow to the outside of the battery cell laminate 100 along the inclined surface of the baffle 300.

Furthermore, the baffle 300 may be formed in the curved surface including the inflection point, which is formed to be rounded (see FIG. 2), but includes the inclined surfaces in front and rear and left and right directions with respect to the inflection point (see FIG. 3) so that the outside air supplied to the inside through the opening 210 may be distributed in the front and rear and left and right directions of the battery cell laminate 100.

The baffle 300 guides the flow of the outside air by shifting a position of the inflection point, that is, a position of a boundary surface A formed to be rounded including the inflection point in FIG. 1 from a center portion of the opening 210 to one side according to the degree of the distribution of the outside air, and in the instant case, the position of the boundary surface A may be changed by adjusting the shape of the baffle 300 depending on the number of battery cells in the front and rear and left and right directions, the width and length of the battery cell, and the like with respect to the position of the opening 210, and for example, the baffle 300 may guide a relatively larger amount of outside air introduced from the opening 210 to flow to the right, in a direction in which more battery cells are laminated with respect to the boundary surface A by shifting the position of the boundary surface A from the center portion of the opening 210 to the left (see FIG. 1).

Furthermore, the baffle 300 may include a through hole H formed to pass through the inside and allow the outside air to be introduced into the battery cell laminate 100.

A plurality of through holes H are formed side by side along the cooling flow path (see FIG. 2), and thus allows the outside air to be supplied to the upper surface of the battery cell laminate 100 shield by the baffle 300, toward the battery cell laminate 100 disposed perpendicular to the opening 210 so that the air volume of the outside air may be uniformly distributed between the battery cells forming the battery cell laminate 100.

Meanwhile, as described above, the baffle 300 may be applied to the structure of the high voltage battery module including the structure in which the inlet 10 is formed on the upper portion, the outside air is supplied and flows and is configured to perform cooling while passing the plurality of battery cells forming the battery cell laminate 100, and then is discharged to the outlet 20, but also applied to a high voltage battery module including a different structure in the same manner.

For example, as shown in FIG. 5, in a structure in which the inlet 10 is formed on a lower portion of the battery cell laminate 100 and cooling wind is introduced into the inside by a separate blower, the baffle 300 may be disposed to perform cooling for a portion adjacent thereto and a portion there behind by different cooling flow paths.

In other words, in the portion adjacent to the baffle 300, the cooling wind of the blower is directly introduced so that the cooling wind including high pressure flows to the battery cell, and in the portion behind the baffle 300, the cooling wind of the blower including relatively lower pressure but relatively higher flow rate and wind volume than the portion adjacent to the baffle 300 by passing the inclined surface of the baffle 300 flows to the battery cell, and thus the cooling wind supplied through the blower may be effectively distributed uniformly between the plurality of cells.

According to an exemplary embodiment of the present disclosure, it is possible to apply the three-dimensional baffle including the streamlined structure to the upper surface of the battery cell laminate at the position facing the inlet and allow the air volume of the outside air introduced through the inlet to be uniformly distributed to the battery cell laminate to improve the differential pressure of the cooling flow path of the air-cooled high voltage battery cell, reducing the temperature deviation between the plurality of battery cells.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery module comprising:
a battery cell laminate formed by arranging a plurality of battery cells;
an upper housing including an opening at a position corresponding to an inlet of a battery module case on an upper surface of the battery cell laminate and including a cooling flow path of outside air introduced through the inlet formed thereon; and
a baffle configured to guide the outside air passing through the opening to flow to the outside of the battery cell laminate along the cooling flow path and formed in a curved surface including an inflection point.

2. The battery module of claim 1,
wherein the baffle is positioned to cover an upper portion of the battery cell laminate under the inlet, and
wherein a predetermined gap is formed between an inner surface of the upper housing and an upper surface of the baffle.

3. The battery module of claim 1, wherein the baffle is coupled to the upper surface of the battery cell laminate and formed in a widthwise length relatively greater than a widthwise length of the opening.

4. The battery module of claim 3, wherein the baffle is formed to have a widthwise length relatively greater than a widthwise length of the opening downwardly from a boundary surface including the inflection point of an upper side having a length relatively shorter than the widthwise length of the opening.

5. The battery module of claim 4, wherein the boundary surface is formed to be shifted from a center portion of the opening to one side thereof.

6. The battery module of claim 1, wherein the baffle includes a through hole so that the outside air is introduced into the battery cell laminate through the through hole.

7. The battery module of claim 6, wherein the through hole is in plural and the plurality of through holes are formed side by side along the cooling flow path.

8. The battery module of claim 1, wherein the baffle is positioned so that the inflection point is shifted from a center portion of the opening to one side to guide a flow of the outside air.

9. The battery module of claim 1, wherein the upper housing includes a downward inclined portion formed to be inclined downwardly from a first end portion on which the opening is formed toward a second end portion facing the outside of the battery cell laminate.

10. The battery module of claim 9, wherein the downward inclined portion is positioned to overlap the baffle.

11. The battery module of claim 9, wherein a gap between an upper surface of the baffle and a lower surface of the downward inclined portion decreases in a direction away from the opening.

12. A battery module comprising:
a battery cell laminate formed by arranging a plurality of battery cells;
an upper housing including an opening at a position corresponding to an inlet of a battery module case on an upper surface of the battery cell laminate and including a cooling flow path of outside air introduced through the inlet formed thereon;
a baffle configured to guide the outside air passing through the opening to flow to the outside of the battery cell laminate along the cooling flow path and formed in a curved surface including an inflection point; and
a through hole passing through the baffle formed so that the outside air is introduced into the battery cell laminate through the through hole.

13. The battery module of claim 12, wherein the through hole is in plural and the plurality of through holes are formed side by side along the cooling flow path.

14. The battery module of claim 12,
wherein the baffle is positioned to cover an upper portion of the battery cell laminate under the inlet, and
wherein a predetermined gap is formed between an inner surface of the upper housing and an upper surface of the baffle.

15. The battery module of claim 12, wherein the upper housing includes a downward inclined portion formed to be inclined downwardly from a first end portion on which the opening is formed toward a second end portion facing the outside of the battery cell laminate.

16. The battery module of claim 15, wherein the downward inclined portion is positioned to overlap the baffle.

17. The battery module of claim 15, wherein a gap between an upper surface of the baffle and a lower surface of the downward inclined portion decreases in a direction away from the opening.
